(19) United States
(12) Patent Application Publication
(10) Pub. No.: US 2005/0079906 A1
(43) Pub. Date: Apr. 14, 2005

(54) Wagering apparatus and method

(76) Inventor: James L. Moore, Grosse Ile, MI (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/958,885

(22) Filed: Oct. 5, 2004

Related U.S. Application Data
(60) Provisional application No. 60/509,106, filed on Oct. 6, 2003.

(51) Int. Cl. G06F 17/00; G06F 19/00

(52) U.S. Cl. 463/6

(57) ABSTRACT

A method and an apparatus for placing wagers on a sporting event includes receiving an order from a purchaser for a secondary wager ticket and a sum of money, tracking the sum of money in an account, and providing to the purchaser the secondary wager ticket having a random number and a probable winning number related to a wager on the sporting event. A portion of the account is paid for each presented winning secondary wager ticket after the sporting event is completed. The secondary wager ticket can be a scratch ticket or a pull tab ticket. The secondary wager ticket can be provided in association with the purchase of a traditional wager ticket.

### CROSS-REFERENCE TO RELATED APPLICATION

This application claims the benefit of U.S. provisional patent application Ser. No. 60/509,106 filed Oct. 6, 2003.

### BACKGROUND OF THE INVENTION

The present invention relates generally to a wagering method and apparatus for use in connection with any sporting event.

Horseracing and wagering on the various racing events are well known. A number of horses are entered into a racing event of a predetermined length around a generally oval track. Typically, a number of races are held on a given day, with each race provided with a consecutive number beginning at one (1). Each horse is provided with a starting gate number and given odds for winning and racing fans are able to place wagers on the horses of each of the races in any number of traditional or nontraditional wagers. Traditional wagers or bets include wagers on a horse to win the race (a Win bet), on a horse to finish first or second in the race (a Place bet), or on a horse finish first, second, or third in the race (a Show bet). Nontraditional wagering, also known in the art as exotic wagering, include wagers on the finishing order of a group of horses such as, but not limited to, an exact order for first and second place finishes (an Exacta bet), an exact order for first, second and third places finishes, (a Trifecta bet), and an exact order for first, second, third, and fourth place finishes (a Superfecta bet). Racetracks typically include a ticket booth or ticket window where the racing fans may place their wagers, receive tickets evidencing the bets made and redeem their winning tickets after the race is complete.

These traditional and nontraditional methods of wagering, however, are well known and have grown stale. Furthermore, in recent years, horseracing has seen increased competition for wagering business in the form of off tracking betting, casinos, as well as state-sponsored lotteries. Horseracing, however, does have advantages over these other types of wagering including the colors and spectacle of the race and horses and the ability to provide live action.

It is desirable, therefore, to provide a new means for wagering on horseracing events and for providing additional fun and excitement to horseracing fans by increasing their chances of obtaining additional winnings placed at the racetrack.

Furthermore, although the apparatus and method according to the present invention have been described above in the context of horseracing, any sporting competition is suitable.

### SUMMARY OF THE INVENTION

The present invention concerns a method and an apparatus for placing wagers at a sporting event such as a ticket booth at a horse track. The apparatus includes: a means for receiving an order from a customer for a traditional wager ticket and an associated secondary wager ticket; a means for generating the traditional wager ticket, the traditional wager ticket including a race number, horse number, and a purchase date; a means for generating the secondary wager ticket, the secondary wager ticket having a race number and a portion including a random number; and a means for tracking a sum of money corresponding to an order for the secondary wager ticket, the means for tracking being operable to deposit the sum of money into a separate account. When an order is placed for the traditional wager ticket and the secondary wager ticket, the secondary wager ticket is date-stamped and the sum of money for the secondary wager ticket is deposited into the separate account, and the traditional wager ticket and the secondary wager ticket are provided to the customer. When the traditional wager ticket and the secondary wager ticket are presented after the race, the traditional wager ticket includes a winning horse number for the race number and a purchase date, the secondary wager ticket includes a race number corresponding to the race number on the traditional wager ticket, a date stamp corresponding to the purchase date on the traditional wager ticket, and a random number corresponding to the wining horse number on the traditional wager ticket, a portion of the separate account in an amount equal to the number of winning traditional wager tickets and associated winning secondary tickets is paid.

The secondary wager ticket can be a scratch ticket and the portion can a scratch portion, or the secondary wager ticket is a pull tab ticket and the portion is a pull tab portion. The traditional wager ticket can include a control number and the secondary wager ticket can include a corresponding control number.

The method comprising the steps of: a) receiving an order from a customer for a traditional wager ticket; b) generating a traditional wager ticket, the traditional wager ticket including a race number, a horse number, and a purchase date; c) receiving an order from the customer for a secondary wager ticket, the order including a sum of money; tracking the sum of money corresponding to the order for the secondary wager ticket and depositing the sum of money into a separate account; generating a secondary wager ticket, the secondary wager ticket having a race number and a portion including a random number; date-stamping the secondary wager ticket; providing the traditional wager ticket and the secondary wager ticket to the customer; and after the race has been run, paying a portion of the separate account in amounts equal to the number of customers presenting a winning traditional wager ticket and a corresponding winning secondary wager ticket, the winning traditional wager ticket including a winning horse number for a race number and a purchase date, said corresponding winning secondary wager ticket including a race number corresponding to the race number on the winning traditional wager ticket, a date stamp corresponding to the purchase date on the winning traditional wager ticket, and a random number corresponding to the wining horse number on the winning traditional wager ticket.

The method also comprises the steps of: a) receiving an order from a purchaser for a secondary wager ticket, the order including a sum of money; b) tracking the sum of money corresponding to the order for the secondary wager ticket and depositing the sum of money into an account; c) providing the secondary wager ticket to the purchaser, the secondary wager ticket having a random number and a probable winning number related to an original wager on a sporting event; d) repeating the steps a) through c) for additional purchasers; and paying a portion of the account in amounts equal to a number of presented winning secondary wager tickets after the sporting event is completed.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic view of a wagering apparatus in accordance with the present invention;

FIG. 2 is a schematic view of an alternate embodiment wagering apparatus in accordance with the present invention; and

FIG. 3 is a perspective view of another alternate embodiment of the present invention.

### DESCRIPTION OF THE PREFERRED EMBODIMENT

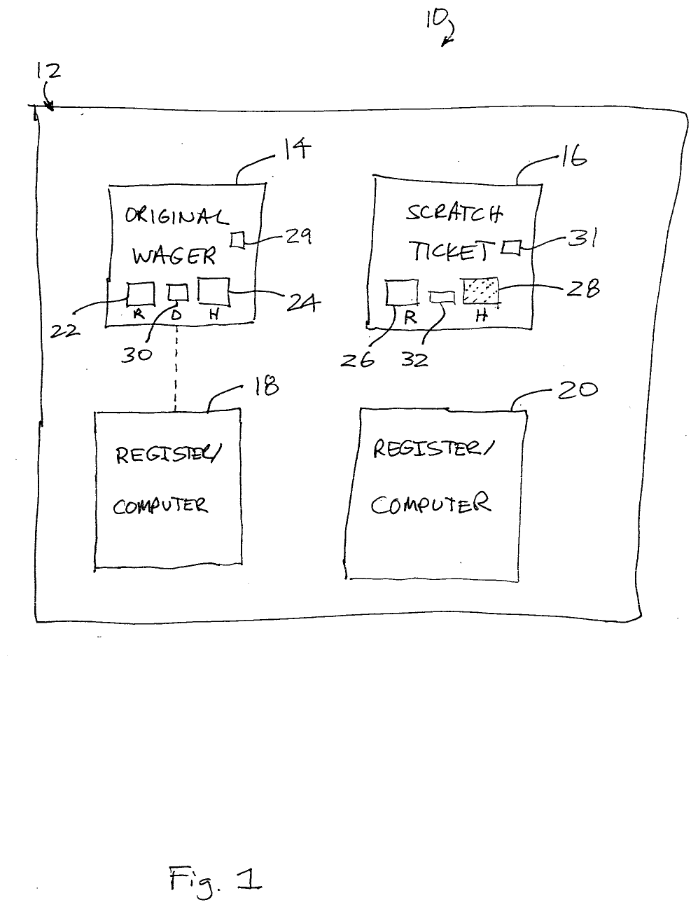

There is shown in FIG. 1 a wagering apparatus 10 in accordance with the present invention. The wagering apparatus 10 includes a ticket booth or window 12 wherein traditional original wager tickets and secondary wager tickets are dispensed to race fans (not shown) after being purchased by the race fans, hereinafter referred to as purchasers and discussed in more detail below.

After a traditional wager (i.e. win, place, show) or nontraditional wager (i.e. exacta, trifecta, superfecta) is placed, an original wager ticket 14 is dispensed. The wager computer or register 18 tracks the amount of the wager and preferably prints the original wager ticket 14. On the face of the ticket 14 is printed a number 22 corresponding to the race number and a number 24 corresponding to the starting gate for the horse upon whom the wager was placed. Additionally, a purchase date 30 is printed on the face of the ticket 14. The computer 18 tracks the amount of money placed on the race and verifies winning wagers when a ticket having numbers 22 and 24 corresponding to the race number and winning horse are presented for payment after the race has been run.

When the traditional wager is placed, the purchaser of the ticket 14 is also given the opportunity place a secondary wager by purchasing a scratch ticket 16 in conjunction with the original wager ticket 14. The scratch ticket 16 is a preprinted ticket with a portion 26 that corresponds to the race number and pole position and a scratch-off portion 28 that corresponds to a random number for starting gates for the horses in the race. Preferably, a plurality of rolls of scratch tickets 16 are provided and correspond in number to the total possible number of races held at a racetrack. Preferably, the face of the scratch tickets 16 are provided with a date stamp 32 by a clerk or a machine (not shown) at the ticket window 12 prior to the purchaser taking possession of the ticket 16. A scratch-off computer or register 20 tracks the number of scratch tickets 16 purchased and the amount of the scratch-off wagers and places each wager into a separate account (not shown) for tracking purposes.

The purchaser removes the scratch-off portion 28 on the scratch ticket 16 to reveal the random numbers at any time after purchase. After a race is completed, and if the purchaser has a winning ticket 14, should the random number of the scratch-off portion 28 correspond to the number 24 of the winning horse and should the number 26 correspond to the number 22 of the race number and should the date-stamp 32 of the scratch ticket 16 correspond to the purchase date 30 on the winning ticket 14, the purchaser is eligible to redeem the scratch ticket 16 for additional winnings. The tickets 14 and 16 are presented to the clerk at the ticket booth 12 for redemption. Preferably, the tickets 14 and 16 are required to be presented to the clerk at the ticket booth 12 before the end of business on the same day corresponding to the purchase date 30 and the date-stamp 32. Both a winning ticket 14 and a corresponding winning scratch ticket 16, therefore, are required to obtain winnings from the separate account. Should there be more than one winning pair of tickets 14 and 16 presented, the winnings from the separate account are divided equally among the number of presenting purchasers.

If there are no winning scratch tickets 16 for a given race presented before the end of business, the money continues to grow for each successive race day after day until a purchaser presents a ticket for redemption, advantageously providing additional excitement and anticipation for each of the successive races. Furthermore, the amount of possible winnings from the separate account may be displayed for advertising purposes in order to spur interest in additional scratch ticket 16 purchases.

Prior to the close of betting on a race, a purchaser could remove the scratch-off portion 28 and then purchase a ticket 14 for the number of the horse corresponding to the number in the scratch-off portion 28. To prevent such action, the ticket 14 can be printed with a control number 29 along with the numbers 22 and 24 and the purchase date 30. The face of the scratch ticket 16 is also preferably stamped with a control number 31 by the clerk when the clerk provides the date stamp 32 at the ticket window 12 prior to the purchaser taking possession of the ticket 16. When presented for redemption, the control numbers 29 and 31 as well as the horse numbers 24 and 28, the race numbers 22 and 26, and the dates 30 and 32 need to match in order for winnings to be paid. The control numbers 29 and 31 could be the time of purchase.

Although the invention has been described in terms of a single horse being identified by the number 24 and the scratch-off number 28, obviously multiple numbers would be used for nontraditional wagers. Furthermore, the odds of winning can be increased by using two or more numbers in the scratch off portion. For example, if ten horses are in the race, the chance of having the winning horse number is one in ten when one number is used for the number 28. If three numbers are used for the number 28, and all three must match the winning horse number, the chances of winning are then one in one thousand.

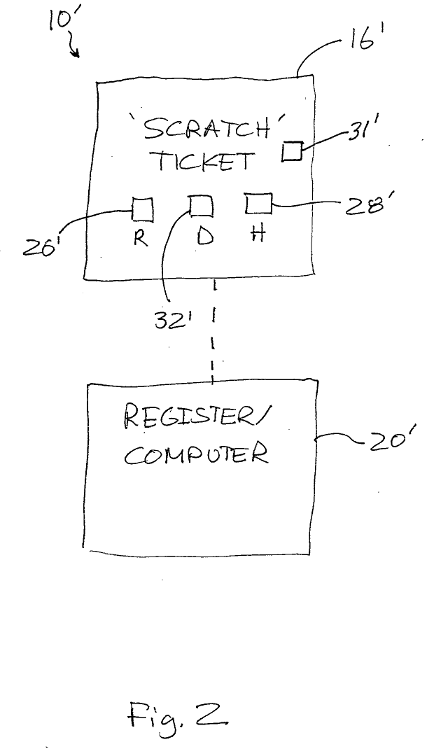

Referring now to FIG. 2, in an alternative embodiment of the wagering apparatus indicated generally at 10′, a scratch ticket 16′ may be purchased separately without requiring the purchase of an original wager ticket 14. In such an embodiment, the ticket 16″ is printed from a computer 20′ with a race number 26′, a random horse number 28′, and a date stamp 32′ preprinted on the face thereof. Should the random number 28′ correspond to the number of the winning horse for the race number 26′ and the date-stamp 32′ correspond to the date of the horse race, the purchaser is eligible to redeem the scratch ticket 16″ for winnings. This embodiment allows a purchaser of the scratch ticket 16″ to gain a chance at the scratch ticket winnings without having to purchase a wager ticket 14. As another alternative, a control number 31′ can be printed thereon corresponding to a horse selected by the purchaser to win the race and then the ticket 16′ would be a winning ticket only if the control number matched the random horse number.

Although the present invention has been described in terms of use at a horse racing facility, it could be utilized at other locations such as a state lottery game or in a casino. Also, the present invention can be used in connection with other types of sporting events such as football games and auto races.

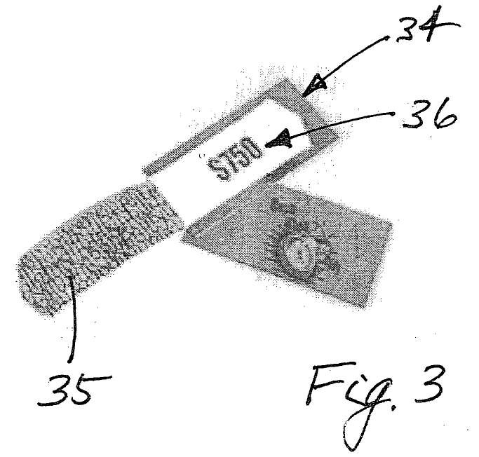

The secondary wager ticket shown as the scratch tickets 16 and 16′ can take other forms such as a conventional pull tab ticket 34 as shown in FIG. 3. The ticket 34 has a pull tab portion 35 that covers a number 36 printed on the ticket. The tab portion 35 has perforated side edges that permit a user to pull back the tab to reveal the number 36.

In accordance with the provisions of the patent statutes, the present invention has been described in what is considered to represent its preferred embodiment. However, it should be noted that the invention can be practiced otherwise than as specifically illustrated and described without departing from its spirit or scope.

1. An apparatus for placing wagers at a ticket booth at a horse track, comprising:
a means for receiving an order from a customer for a traditional wager ticket and an associated secondary wager ticket;
a means for generating said traditional wager ticket, said traditional wager ticket including a race number, horse number, and a purchase date;
a means for generating said secondary wager ticket, said secondary wager ticket having a race number and a portion including a random number;
a means for tracking a sum of money corresponding to an order for said secondary wager ticket, said means for tracking being operable to deposit said sum of money into a separate account;
whereby when an order is placed for said traditional wager ticket and said secondary wager ticket, said secondary wager ticket is date-stamped and the sum of money for said secondary wager ticket is deposited into the separate account, and said traditional wager ticket and said secondary wager ticket are provided to the customer, and
whereby when said traditional wager ticket and said secondary wager ticket are presented after the race, said traditional wager ticket includes a winning horse number for the race number and a purchase date, said secondary wager ticket includes a race number corresponding to the race number on said traditional wager ticket, a date stamp corresponding to the purchase date on said traditional wager ticket, and a random number corresponding to the wining horse number on said traditional wager ticket, a portion of the separate account in an amount equal to the number of winning traditional wager tickets and associated winning secondary tickets is paid.

2. The apparatus according to claim 1 wherein said secondary wager ticket is a scratch ticket and said portion is a scratch portion.

3. The apparatus according to claim 1 wherein said secondary wager ticket is a pull tab ticket and said portion is a pull tab portion.

4. The apparatus according to claim 1 wherein said traditional wager ticket includes a control number and said secondary wager ticket includes a corresponding control number.

5. A method for placing wagers at a horse track comprising the steps of:
a) receiving an order from a customer for a traditional wager ticket;
b) generating a traditional wager ticket, the traditional wager ticket including a race number, a horse number, and a purchase date;
c) receiving an order from the customer for a secondary wager ticket, the order including a sum of money;
d) tracking the sum of money corresponding to the order for the secondary wager ticket and depositing the sum of money into a separate account;
e) generating a secondary wager ticket, the secondary wager ticket having a race number and a portion including a random number;
f) date-stamping the secondary wager ticket;
g) providing the traditional wager ticket and the secondary wager ticket to the customer; and
h) after the race has been run, paying a portion of the separate account in amounts equal to the number of customers presenting a winning traditional wager ticket and a corresponding winning secondary wager ticket, the winning traditional wager ticket including a winning horse number for a race number and a purchase date, the corresponding winning secondary wager ticket including a race number corresponding to the race number on the winning traditional wager ticket, a date stamp corresponding to the purchase date on the winning traditional wager ticket, and a random number corresponding to the wining horse number on the winning traditional wager ticket.

6. The method according to claim 5 wherein steps a) through g) are repeated for any given number of purchasers.

7. A method for placing wagers comprising the steps of:
a) receiving an order from a purchaser for a secondary wager ticket, the order including a sum of money;
b) tracking the sum of money corresponding to the order for the secondary wager ticket and depositing the sum of money into an account;
c) providing the secondary wager ticket to the purchaser, the secondary wager ticket having a random number and a probable winning number related to an original wager on a sporting event;
d) repeating said steps a) through c) for additional purchasers; and
e) paying a portion of the account in amounts equal to a number of presented winning secondary wager tickets after the sporting event is completed.

8. The method according to claim 7 wherein said step c) is performed by providing the secondary wager ticket as a scratch ticket and the portion being a scratch portion.

9. The method according to claim 7 wherein said step c) is performed by providing the secondary wager ticket as a pull tab ticket and the portion being a pull tab portion.
